(19) United States
(12) Patent Application Publication
(10) Pub. No.: US 2022/0138445 A1
(43) Pub. Date: May 5, 2022

(54) Remote infrared ink reader and authenticator

(71) Applicant: VerifyMe, Inc., Rochester, NY (US)

(72) Inventor: Keith Goldstein, Framingham, MA (US)

(21) Appl. No.: 17/512,230

(22) Filed: Oct. 27, 2021

Related U.S. Application Data
(60) Provisional application No. 63/109,646, filed on Nov. 4, 2020.

(51) Int. Cl. G06K 7/12; G06K 7/10; G06K 7/08

(52) U.S. Cl. CPC G06K 7/12; G06K 7/089; G06K 7/10821; G06K 7/10732

(57) ABSTRACT

Systems, methods, and apparatus for reading and authenticating an infrared mark made with infrared (IR) ink. The IR ink reader and authenticator system includes a visible projection subsystem, an optical block, an imaging subsystem, a processing and control subsystem, and at least one enclosure. The infrared ink reader and authenticator system is preferably operable to validate both the infrared mark made with the infrared ink and a visible mark. Data related to the infrared mark and the visible mark is stored in a database.

### PRIORITY CLAIM

In accordance with 37 C.F.R. 1.76, a claim of priority is included in an Application Data Sheet filed concurrently herewith. Accordingly, the present invention claims priority based upon U.S. Provisional Patent Application No. 63/109,646 filed Nov. 4, 2020, and entitled “REMOTE INFRARED INK READER AND AUTHENTICATOR.” the contents of which are incorporated herein by reference.

### FIELD OF THE INVENTION

The present invention relates to authentication of documents and goods, and more specifically to a remote infrared ink reader and authenticator.

### BACKGROUND OF THE INVENTION

It is generally known in the prior art to provide authentication of documents and goods. The document or goods may include a source indicator to indicate the source of the document or good. Further, the document or good may include a hidden mark that is operable to be detected by various means, such as optical lenses, light illumination, or coding.

Authenticating goods or documents is necessary to protect consumers and manufacturers. Counterfeiters often target items or goods with significant brand equity and/or those that command a higher price than average. The counterfeit goods are often of inferior quality to the authentic goods. However, the counterfeit goods may be difficult for consumers, manufacturers, and customs officers to detect.

Prior art patent documents include the following: U.S. Pat. No. 7,905,412 for Bar code processing is directed to an image processing apparatus including a first image reading unit configured to read an image from an object to be read by visible light, a second image reading unit configured to read an image from the object to be read by invisible light, a first detection unit configured to detect a background image from a first read image read by the first image reading unit, a registration unit configured to register feature information indicative of a feature of the background image detected by the first detection unit, and a second detection unit configured to detect an image indicative of code information from a second read image read by the second image reading unit on the basis of the feature information registered in the registration unit.

U.S. Pat. No. 8,403,223 for Invisible-fluorescent identification tags is directed to a taggant composition including a taggant material that is invisible in light of the visible spectrum and fluoresces under a non-visible excitation energy, a binder, and a solvent in which the taggant material and the binder are dissolved. The taggant composition can be printed or otherwise applied to a material such as fabric to provide a detectable and identifiable indicium. A method and apparatus for detecting and decoding the taggant indicium are also provided.

U.S. Pat. No. 7,046,346 for Optoelectronic document reader for reading UV/IR visible indicia is directed to a document reader for optoelectronically illuminating, reading and interpreting (i.e. processing and analyzing) indicia appearing on a document in a machine readable zone thereof, wherein the indicia is made visible only under illumination by non-visible light (i.e. UV or IR). UV (or IR) light sources (LED's) of the reader are rapidly switched to a stable, peak UV (or IR) illumination frequency or frequency range to illuminate and render visible such covert UV-visible (or IR-visible) indicia. An optoelectronic image sensor (CCD) captures the document image, which includes the indicia rendered visible by the UV source illumination, and the covert indicia is identified from the captured image. An optical path, being folded by two mirrors so as to provide a compact geometry for the reader, extends between a reading surface on which the document is place and the image sensor. A lens configured for focusing light defining an image onto the sensor is provided in the optical path. The reader may also include bank(s) (array(s)) of visible light sources (LED's), for illuminating visible indicia, in addition to UV and IR LED arrays and any IR light sources may also be used for illuminating visible OCR characters according to ISO 1831. A controller is provided to sequentially activate each different light source bank.

U.S. Pat. No. 10,671,823 for Reader apparatus for upconverting nanoparticle ink printed images is directed to a system and method for reading an upconversion response from nanoparticle inks is provided. A laser is adapted to direct a near-infrared excitation wavelength at a readable indicia, resulting in a near-infrared emission wavelength created by the upconverting nanoparticle inks. A short pass filter may filter the near-infrared excitation wavelength. A camera is in operable communication with the short pass filter and receives the near-infrared emission wavelength of the readable indicia. The system may further include an integrated circuit adapted to receive the near-infrared emission wavelength from the camera and generate a corresponding signal. A readable application may be in operable communication with the integrated circuit. The readable application receives the corresponding signal, manipulates the signal, decodes the signal into an output, and displays and/or stores the output.

U.S. Pat. No. 9,983,410 for Device and method for authentication of a document is directed to a method and a device for authenticating information contained in a document, said device including at least one imager configured for acquiring at least one image of an acquisition field, at least one light source, computer processing means configured for processing the image and for extracting therefrom data relating to the document, said device being adapted so as to be mounted on the head of a user so that its acquisition field covers at least one portion of the field of vision of the user, the light source being configured so as to emit in the acquisition field of the imager, a light of at least one non-visible wavelength, the imager being adapted for allowing acquisitions at said wavelength and thus allowing acquisition at this wavelength of an image of a document presented to the user in the acquisition field of the imager. The invention also relates to the corresponding method.

U.S. Pat. No. 10,185,945 for Multifunction point of sale system is directed to a point of sale system capable of operating in an indicia-reading mode or a verification mode. In the indicia-reading mode, the point of sale system configures its illumination, imaging, and processing to read indicia as part of a normal checkout process. If triggered by a user or by an event, the point of sale system may operate in a verification mode. In the verification mode, the point of sale system enables the necessary illumination, imaging, and processing to verify an item. This verification includes illuminating the item in a way that causes a noticeable response from a security mark (or marks) on the item. An image of the response may be captured and processed to authenticate/verify the item. The point of sale system may then respond to the verification and/or may store the image/results as a record of the verification.

U.S. Pat. No. 8,653,445 for Method for viewing invisible indicia is directed to a method for detecting and viewing invisible indicia including illuminating the invisible indicia with radiation of a first wavelength with an illumination source; detecting emitted light from the invisible indicia at a second wavelength with a sensor array; eliminating reflected radiation at the first wavelength; focusing an image of the invisible indicia on the sensor array; displaying the image of the invisible indicia; spacing the sensor array at a fixed distance from the invisible indicia with a spacer, and adjusting sensitivity of the sensor array.

U.S. Pat. No. 6,832,729 for Portable data collection device for reading fluorescent indicia is directed to portable data collection device for reading fluorescent indicia, such as barcodes. The device includes a housing with a pivotable image capture module. The image capture module includes an adjustable aperture, a color detector array for imaging light received through the aperture, and a removable flash module to provide ultraviolet light. Optics in the image capture module focus the light received through the aperture onto the detector array, in which the detector array is movable with respect to the lens to provide proper focus of an image onto the detector array. The adjustable aperture has an iris wheel to control the amount of light received by the detector array. A programmed controller is provided in the housing which operates responsive to a user interface to image and decode indicia, or capture color digital images in memory. A display on the housing shows images received by the detector array in a non-fluorescent imaging mode to target indicia to be imaged and decoded, where the controller automatically adjusts the focus of the image by adjusting the focal distance between the detector array and the lens. In response to user actuation via the user interface, the controller energizes the flash module to emit light, including the excitation wavelength(s), which enable the indicia to fluoresce, and the detector array receives fluorescent light to capture an image frame of the indicia. The duration of the flash is in accordance with the amount of light measured by a light sensor in the image capture module. The indicia in the image frame is then decoded by the controller to provide data representative of the indicia.

U.S. Pat. No. 8,408,468 for Method of and system for reading visible and/or invisible code symbols in a user-transparent manner using visible/invisible illumination source switching during data capture and processing operations, is directed to a method of and system for reading visible and/or invisible code symbols in a user-transparent manner using visible/invisible illumination switching during data capture and processing operations.

### SUMMARY OF THE INVENTION

The present invention relates to authentication of documents and goods, and more specifically to a remote infrared ink reader and authenticator.

It is an objective of this invention to provide systems, methods, and apparatuses for authenticating documents and/or goods by verifying an invisible code and/or mark placed on the documents and/or goods.

In one embodiment, the present invention provides a method of using a remote infrared ink reader and authenticator as described herein.

In another embodiment, the present invention provides a system for using a remote infrared ink reader and authenticator as described herein.

In yet another embodiment, the present invention provides an apparatus for remote infrared ink reading and authenticating as described herein.

An objective of the invention is to teach the use an infrared ink (IR) that is invisible to the human eye and employs an IR up-converting pigment that is stable over time in ambient light.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 illustrates one embodiment of a remote infrared ink reader and authenticator.

FIG. 2 illustrates one embodiment of the remote infrared ink reader and authenticator as a handheld device.

FIG. 3 illustrates one embodiment of the remote infrared ink reader and authenticator as an industrial unit.

FIG. 4A illustrates one example of a method of using the remote infrared ink reader and authenticator system.

FIG. 4B illustrates the method of using the remote infrared ink reader and authenticator system continued from FIG. 4A.

FIG. 5 is a schematic diagram of a system of the present invention.

FIG. 6 is a graft of the excitation wavelength.

### DETAILED DESCRIPTION

The present invention is generally directed to authentication of documents and goods, and more specifically to a remote infrared ink reader and authenticator.

In one embodiment, the present invention provides a method of using a remote infrared ink reader and authenticator as described herein.

In another embodiment, the present invention provides a system for using a remote infrared ink reader and authenticator as described herein.

In yet another embodiment, the present invention provides an apparatus for remote infrared ink reading and authenticating as described herein.

None of the prior art discloses an infrared ink reader and authenticator operable to read at least one infrared mark without requiring shielding of the at least one infrared mark from ambient light. Advantageously, infrared ink is harder to detect than ink which is commonly used to print hidden marks, such as ultraviolet ink. However, infrared ink typically requires shielding from ambient light to be activated and read. There is a long-felt, unmet need for an infrared ink reader and authenticator that is operable to read at least one infrared mark without requiring shielding of the at least one infrared mark from ambient light.

Referring now to the drawings in general, the illustrations are for the purpose of describing one or more preferred embodiments of the invention and are not intended to limit the invention thereto.

Prior art patents by the Applicant related to document authentication include U.S. Pat. Nos. 6,483,576; 6,672,718; 6,813,011; 7,939,239; 8,841,063; 9,183,688; and 9,159,016, all of which are incorporated herein by reference.

The infrared (IR) ink reader and authenticator system of the present invention is operable to read at least one mark. In a preferred embodiment, the at least one mark is printed, ablated, and/or otherwise provided as an IR mark and/or a visible mark. In one embodiment, the at least one mark is an alphanumeric, a symbol, a quick response (QR) code, any type of barcode symbology, a dot pattern, a digital watermark, a signature, and/or an image.

Infrared (IR) ink is invisible to the human eye, which can only see between about 400 nm (violet) to about 700 nm (red). In a preferred embodiment, the infrared ink includes an IR up-converting pigment. The IR up-converting pigment converts IR light to visible light by absorbing lower energy photons and emitting higher energy photons as fluorescence. At least two low energy photons are absorbed by the IR up-converting pigment to emit one high energy photon. This process requires a high intensity light source (e.g., laser, a plurality of IR light emitting diodes (LEDs)). Additionally, this process typically requires a controlled lighting environment that limits ambient light. In one embodiment, the IR up-converting pigment includes a phosphor. In one embodiment, the IR up-converting pigment includes at least one of doped or undoped metal oxides, doped metal sulfides, metal selenides, metal oxysulfides, rare-earth oxysulfides, and/or mixed oxides. In one embodiment, the IR up-converting pigment has a particle size of about 2 microns (e.g., 2 microns±10%). Alternatively, the IR up-converting pigment has a particle size of between about 1 micron (e.g., 0.1 micron±10%) to about 10 microns (e.g., 6 microns±10%). The preferred IR up-converting pigment is a metal oxysulfide phosphor having a particle size distribution—by Coulter Counter (50 μm Aperture) with ultrasonic dispersion, sizes at listed Volume %

| | vol % | | | | |
|---|---|---|---|---|---|
| | 5 | 25 | 50 | 75 | 95 |
| μm | 0.6 | 1.1 | 1.5 | 2.2 | 3.5 with a Quartile Deviation: 0.33. |

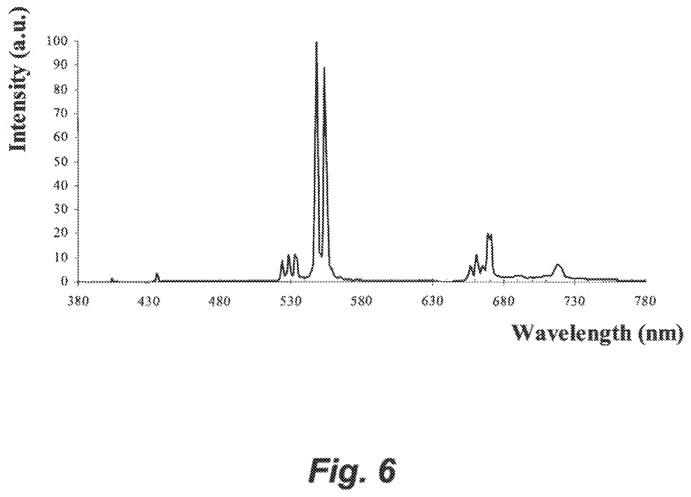

In a preferred embodiment the optical property is a green emission color. However, red, blue or a combination of green, red and blue emission colors may be employed. Wavelength peaks of 548 nm and 554 nm and excitation peaks of 950 nm and 980 nm as illustrated in FIG. 6.

Advantageously, the IR up-converting pigment is stable over time in ambient light. In contrast, UV pigments are generally not light stable and often degrade in the presence of ambient light. For example, many UV pigments begin degrading after 1-2 weeks when exposed to sunlight. Additionally, the IR up-converting pigment is not as easy to detect as a UV pigment because the equipment used to illuminate and detect the IR up-converting pigment is not as easily obtained. Further, the IR up-converting pigment is harder to obtain by counterfeiters than a UV pigment.

In one embodiment, the IR ink reader and authenticator system is operable to read the at least one mark in a non-darkened ambient environment. In one embodiment, the IR ink reader and authenticator is operable to read the at least one mark from a distance of about 1 ft (e.g., 1 ft±10%) to about 6 ft (e.g., 6 ft±10%). Various sensors and LED's may further extend the distances. Advantageously, the IR ink reader and authenticator system includes at least one filter to block visible light, which allows for the IR ink reader and authenticator to be used in ambient light (e.g., artificial light indoors).

In one embodiment, the at least one mark encodes data on a document and/or a good (e.g., label). The data is encoded within the at least one mark using a pigment that is visible under ambient light and/or IR light. In another embodiment, the data is encoded within the at least one mark using a pigment that is visible under ambient light, IR light, and/or UV light. In one embodiment, the system includes at least one UV mark and at least one IR mark. Advantageously, using the at least one UV mark and the at least one IR mark provides additional security for the document and/or the good.

The IR ink reader and authenticator system optionally includes a visible projection subsystem, an optical block, an imaging subsystem, a processing and control subsystem, and/or at least one enclosure.

The visible projection subsystem is operable to project a visible pattern onto an area containing one or more of the at least one mark. Advantageously, this allows the IR ink reader and authenticator to be pointed to at least one visible mark and/or at least one IR mark. This also allows the IR ink reader and authenticator to be aimed in a permanent installation environment. In one embodiment, the visible projected pattern is provided by a red laser pointer with appropriate lensing. In one embodiment, the appropriate lensing includes at least one cylindrical lens and/or at least one semi-cylindrical lens. A shape of the visible projected pattern is operable to be changed by varying the lens shape.

In one embodiment, the present invention includes a method of projecting the visible pattern onto the area containing one or more of the at least one mark. The IR ink reader and authenticator is aimed in a direction of the at least one visible mark and/or the at least one IR mark. A reading of the at least one visible mark and/or the at least one IR mark is then obtained by the IR ink reader and authenticator. In one embodiment, the reading includes capture of at least one image (e.g., still image, video).

The optical block includes illumination through an IR LED or IR Laser, a mirror beam splitter, and a filter. The IR laser is a pulse radiation projection subsystem provides laser beam forming optical components. In one embodiment, the IR laser pulse radiation projection subsystem operates at an excitation wavelength of the IR ink (e.g., 950 nm to 980 nm). The IR laser pulse radiation projection subsystem is operable to project IR laser pulses onto the target to activate the IR ink in one or more of the at least one mark to make it fluoresce. The mirror beam splitter and the filter (e.g., 550 nm) are operable to allow a fluorescing mark to be read by passing it to the imaging subsystem. In another embodiment the IR LED has beam shaping optics for illumination.

The imaging subsystem includes a camera block and a laser driver subsystem. The camera block includes an image sensor and optics. The camera block is responsible for capturing a visible signature and/or an IR signature of the at least one mark. The laser driver subsystem is operable to drive the laser and synchronize the laser radiation pulses with the image capture. The laser driver subsystem is further operable to modulate an intensity of the laser. In one embodiment, the image sensor is a still image camera. Alternatively, the image sensor is a video camera. In one embodiment, a plurality of still images and/or frames is obtained for each mark. In one embodiment, a frame rate for the image sensor is synchronized to a pulse frequency of the laser.

In one embodiment, the processing and control subsystem includes at least one processor, at least one memory, at least one power management integrated circuit (PMIC), and a plurality of communication interfaces. The processing and control subsystem is operable to provide image processing, security and/or encryption of messages, communication functions, and/or power management functions. In one embodiment, the processing and control subsystem is further operable to interface with a display, a keypad, and/or a touch screen (e.g., for system status monitoring and control). In one embodiment, the processing and control subsystem is operable to stitch together at least two of the plurality of still images and/or frames to read the at least one mark.

In one embodiment, the at least one enclosure is a single enclosure (e.g., handheld device). Alternatively, the at least one enclosure is a plurality of enclosures. In one embodiment, the at least one enclosure includes at least one processing unit (e.g., central processing unit (CPU)) enclosure housing at least one processor and at least one memory and at least one scanner enclosure housing an optical block, an imaging subsystem, and/or a serializer. Advantageously, the plurality of enclosures allows for multiple scanners to interface with a single CPU.

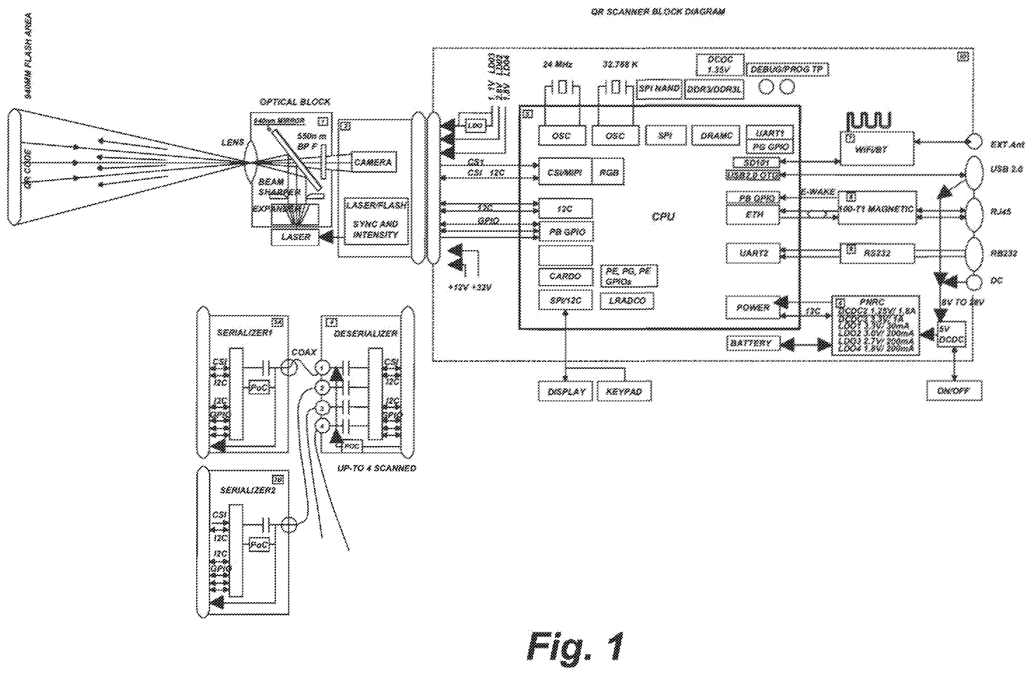

FIG. 1 illustrates one embodiment of a remote infrared ink reader and authenticator. The remote infrared (IR) ink reader and authenticator includes an optical block, an imaging subsystem, a central processing unit (CPU), at least one power management integrated circuit (PMIC), a plurality of communication interfaces, and a housing.

In one embodiment, the optical block provides an IR laser pulse radiation projection subsystem containing laser beam forming optical components. The laser beam forming optical components correspond to an excitation wavelength of the IR ink. In a preferred embodiment, the laser beam forming optical components operate at a wavelength of about 940 nm (e.g., 940 nm±10%) or about 950 nm (e.g., 950 nm±10%). The laser beam forming optical components project IR laser pulses onto a target with a mark to activate the IR ink and make it fluoresce. An output power of the IR laser pulses is preferably sufficient to provide a good signal to noise ratio (S/N) of the image. The optical block includes a semitransparent mirror (e.g., for 940 nm-950 nm).

The optical block further includes a mirror beam splitter and at least one filter. In one embodiment, one or more of the at least one filter is a narrow band pass filter (e.g., a 550 nm narrow band pass filter). The narrow band pass filter blocks wavelengths other than the fluorescing mark wavelength. That is, the narrow band pass filter is selective for the fluorescing mark wavelength. The narrow band pass filter allows the fluorescing mark to be read by passing it to the imaging subsystem. In one embodiment, the at least one filter includes a chromatic filter or a polarization filter. In one embodiment, the at least one filter includes a notch filter and/or a defractive filter. In one embodiment, the at least one filter is included in a switchable filter bank.

The optical block also includes a lens, a beam expander, and/or a beam shaper. A focal length of the lens depends on a distance to the mark. The beam expander expands the laser beam pulse to a required size. The beam shaper reduces the beam intensity differences over the pulsed area.

The imaging subsystem is responsible for capturing the visible or IR signature. The imaging subsystem includes a camera block containing an image sensor with optics and a laser driver subsystem. The laser driver subsystem is operable to drive the laser, synchronize the laser radiation pulses with the image capture, and/or modulate an intensity of the laser. A power, a duration, a pulse, and/or a frequency of the laser is dependent on characteristics related to the at least one mark including, but not limited to the IR up-converting pigment, a particle size of the IR up-converting pigment, a concentration of the IR up-converting pigment in ink, a deposition method (e.g., printing) of the ink, and/or a thickness of the ink and a substrate on which the ink is printed or otherwise placed.

Resolution requirements of the image sensor depend on a complexity of the image (e.g., QR code, barcode, serial number, etc.). In one embodiment, the image sensor is a 1 to 2 MP or greater image sensor (i.e., SD/HD). In another embodiment, the image sensor is a 5 to 8 MP or greater image sensor (i.e., HD/UHD).

In one embodiment, the remote infrared ink reader and authenticator includes a serializer and a de-serializer. The serializer and the de-serializer are operable to provide for a multi-reader system, which allows for multiple scanners (e.g., optical block and imaging subsystem) to use the same control and processing subsystem. Further, the serializer and the de-serializer are operable to extend a distance of remote placed scanners (e.g., 3A, 3B, etc.). In another embodiment an industrial camera employing a sensor and FPGA for converting MIPI data from the sensor data on an USB bus, including some processing. In this embodiment the pulse generator is included along the camera and a control and processing system can be positioned “far away” and connected by USB to the camera.

The at least one processor performs a plurality of functions including, but not limited to, analyzing images (e.g., fluorescing QR code pattern), decoding the marks in the images (e.g., reads the QR code), applying algorithms for error corrections, applying a time stamp at the time of image capture and/or decoding (e.g., QR code reading), establishing communication with other devices (e.g., external servers, readers), preparing messages to send over active interfaces, acting like a client in network environments (e.g., local area network (LAN), WI-FI, serial), and/or supporting local connection to mobile devices over BLUETOOTH or similar technologies. In one embodiment, the at least one processor is incorporated into a desktop computer, a laptop computer, a tablet, and/or a smartphone.

In one embodiment the at least one processor is connected to at least one memory wherein the device captures data for later retrieval and review or analysis. In one embodiment, the at least one memory includes flash memory (e.g., NAND flash, NOR flash).

In one embodiment, the at least one processor is in network communication (e.g., wired, wireless) communication with an optional display, a keypad, and/or a touch screen. Advantageously, the display, the keypad, and/or the touch screen provide system status monitoring and control. In one embodiment, the display is a monitor (e.g., desktop computer, laptop computer), a tablet, and/or a smartphone. The display provides real-time feedback to the user, more importantly than “system status monitoring and control”. In the case of a grading system, the “output interface” can be the QR code image or any barcode symbology, or the grading status (pass/fail/scalar/vector), or measuring a static image luminescence. The touch screen is an input interface used to configure the device, for example setting up communication parameters, system time, and functional parameters such as power line frequency.

The at least one PMIC delivers all necessary power supply voltages for the system. PMIC is an instance or power distribution circuitry. In one embodiment, the at least one PMIC includes direct current (DC) to DC conversion. The at least one PMIC is preferably operable to select a power source. In one embodiment, the at least one PMIC provides battery management and battery charging (e.g., when used as a portable device). Powering of the illuminator (a CC-CV source) can take place by a USB-C interface used for charging, data transfer. An Ethernet emulation can be used so that the device appears on a network with the controlling computer. Serial and JTAG interfaces would be available inside the enclosure. JTAG may be fuse-disabled after production.

The remote infrared ink reader and authenticator provides a plurality of communication interfaces including, but not limited to, LAN (e.g., for connecting to an Ethernet network), WI-FI (e.g., for connecting to a wireless network), BLUETOOTH (e.g., for connecting to a mobile device), and/or serial (e.g., for programming and system management).

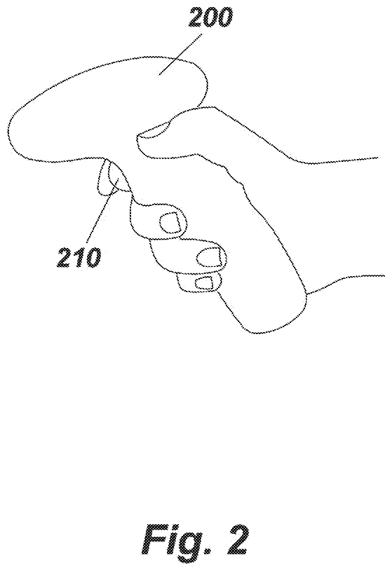

In one embodiment, the remote infrared ink reader and authenticator is a handheld device as shown in FIG. 2. The handheld version most probably needs a power button and a trigger button; the reader actively illuminates and scans (meaning consumes significant power) while the trigger button is active. The trigger button can be used to enter an alternative boot mode, eg. boot from USB if present.

In one embodiment, the remote infrared ink reader and authenticator 200 includes a trigger 210 operable to initiate reading at least one mark. In one embodiment, the remote infrared ink reader and authenticator 200 is powered using a battery. Alternatively, the remote infrared ink reader and authenticator 200 is powered using alternating current. In one embodiment, the remote infrared ink reader and authenticator 200 includes a display, at least one switch, at least one button, and/or a keypad. In one embodiment, the display is a touch screen. In one embodiment, the remote infrared ink reader and authenticator displays any detected marks on the display. In one embodiment, one or more of the at least one switch and/or the at least one button is operable to toggle between a visible mode and an infrared mode.

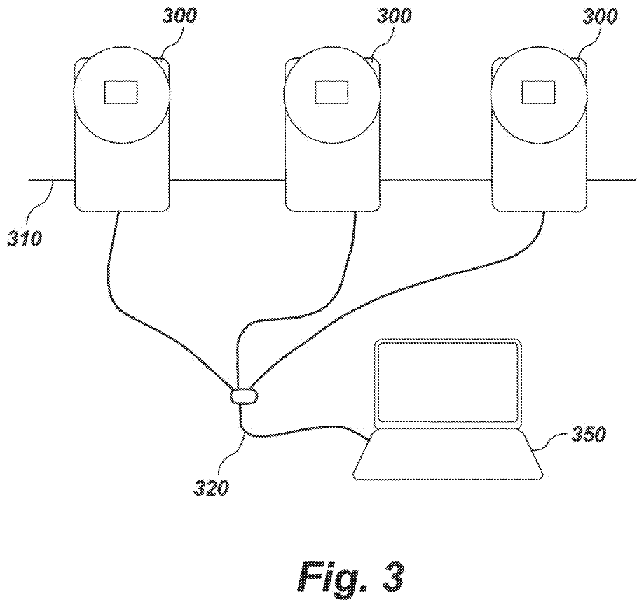

In another embodiment, the remote infrared ink reader and authenticator is an industrial unit (e.g., for installation in a production environment) as shown in FIG. 3. The remote infrared ink reader and authenticator is operable to be mounted on a printing press, on a production line, and/or within other industrial environments. Advantageously, this allows the remote infrared ink reader and authenticator to provide verification, quality control, enrollment in databases (e.g., local, cloud), on the printing press, on the production line, and/or within the other industrial environment.

As shown in FIG. 3, a plurality of remote infrared ink reader and authenticator devices 300 are mounted on a shelf 310. Each of the plurality of remote infrared ink reader and authenticator devices 300 include a lens 320 operable to allow IR light (e.g., from a laser) to pass through the lens 320 and operable to allow for capture of a signature of the at least one mark. The plurality of remote infrared ink reader and authenticator devices 300 are linked to a computing device 350 via a cable 330. Although the example shown in FIG. 3 includes three remote infrared ink reader and authenticator devices 300, the present invention is operable with a different number of remote infrared ink reader and authenticator devices (e.g., 1, 2, 4, etc.). The number of remote infrared ink reader and authenticator devices depends on a configuration of the printing press, the production line, and/or the other industrial environment. For example, if a printing press has six lanes, the number of remote infrared ink reader and authenticator devices required is six (i.e., one for each lane).

The system includes at least one database operable to store the data related to the at least one mark. In one embodiment, the at least one database is located on a remote server, a cloud, and/or an edge device (e.g., node). In one embodiment, the at least one database is connected (e.g., wired, wirelessly) to the at least one processor. Alternatively, the at least one database is stored in one or more of the at least one memory in the processing and control subsystem.

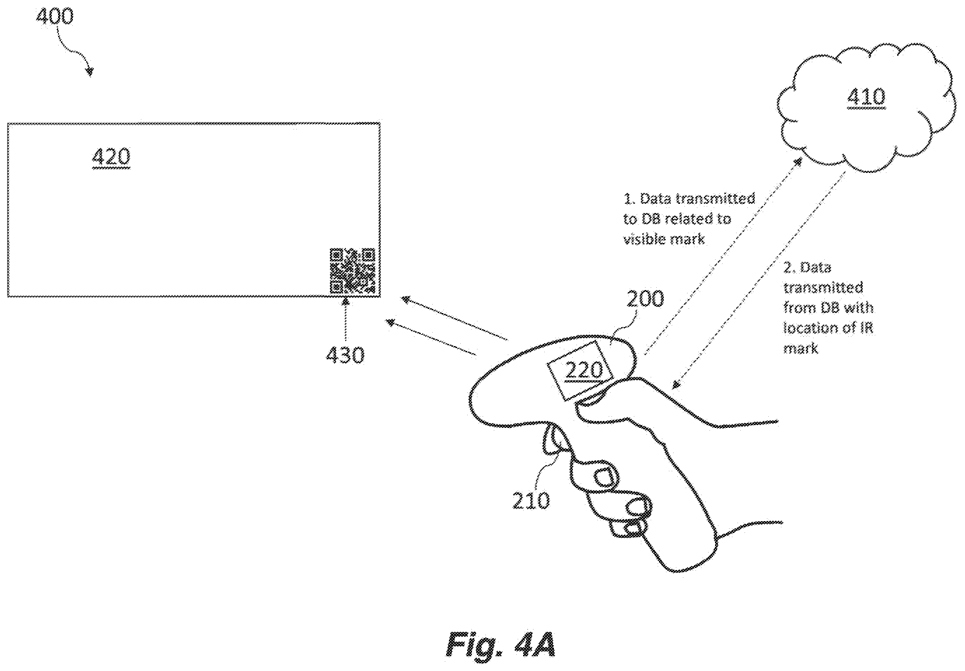

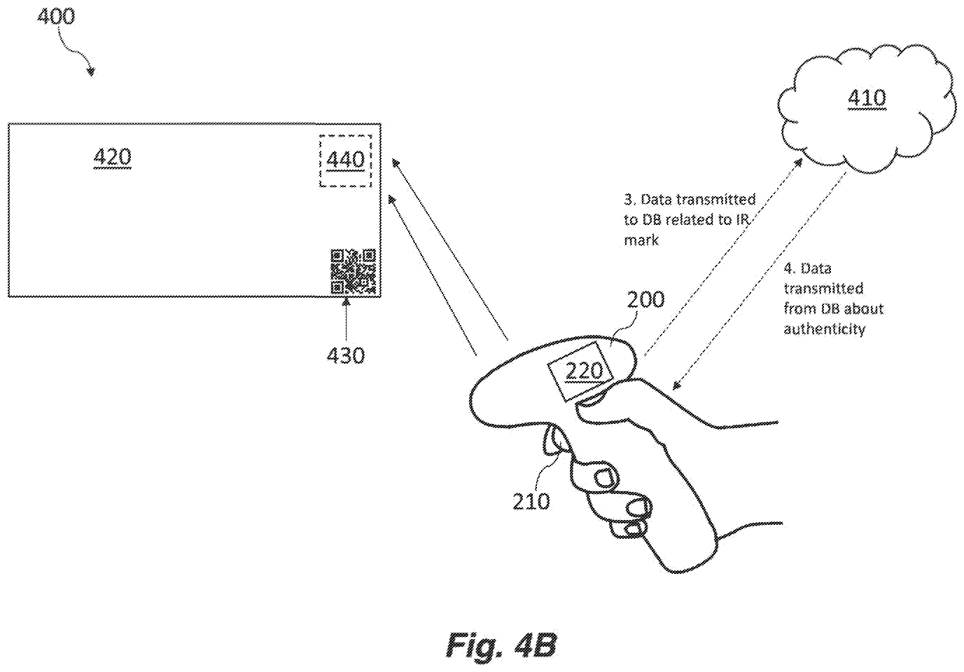

In a preferred embodiment, the document and/or the good includes a visible mark and an IR mark. The visible mark and the IR mark are preferably associated, and provide dual verification of authenticity. The visible mark is decoded by the at least one processor and/or transmitted to the at least one remote server, the at least one cloud, and/or the at least one edge device. In one embodiment, the at least one remote server, the at least one cloud, and/or the least one edge device associates the visible mark with the IR mark. In a preferred embodiment, data associated with the IR mark is transmitted to the at least one processor and is operable to viewed on the display or a remote device (e.g., smartphone). A message verifying the authenticity of the good is transmitted from the cloud to the at least one processor and viewed on the display FIGS. 4A-4B illustrate one example of a method of using the remote infrared ink reader and authenticator system. A visible mark 430 (e.g., QR code) on a label 420 is captured by a remote infrared ink reader and authenticator 200 and transmitted to a cloud 410. A location of an IR mark 440 is stored in a database in the cloud 410, transmitted from the cloud 410 to the at least one processor, and viewed on the display 220. The scanner checks the location of the IR mark 440 using a laser pulse operable to activate the IR mark. The IR mark is transmitted to the cloud 410, and the association between the visible QR code and the IR mark is verified in the database. A message verifying the authenticity of the good is transmitted from the cloud to the at least one processor and viewed on the display.

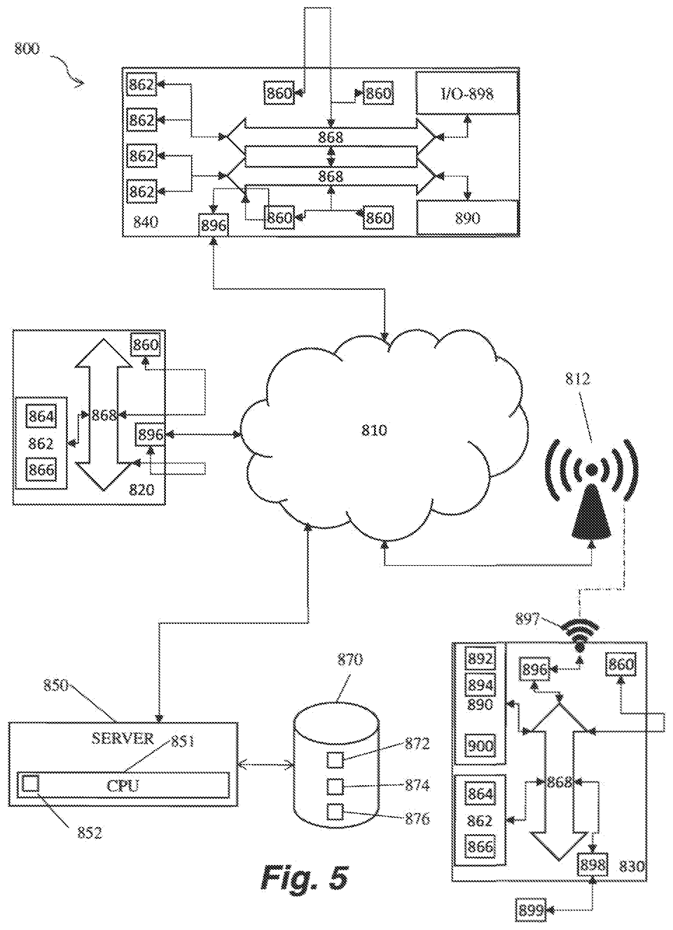

FIG. 5 is a schematic diagram of an embodiment of the invention illustrating a computer system, generally described as 800, having a network 810, a plurality of computing devices 820, 830, 840, a server 850 and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 is operable to house an operating system 872, memory 874, and programs 876.

In one embodiment of the invention, the system 800 includes a network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE. Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 is operable to be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application.

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 is operable to additionally include components such as a storage device 890 for storing the operating system 892 and one or more application programs 894, a network interface unit 896, and/or an input/output controller 898. Each of the components is operable to be coupled to each other through at least one bus 868. The input/output controller 898 is operable to receive and process input from, or provide output to, a number of other devices 899, including, but not limited to, alphanumeric input devices, mice, electronic styluses, display units, touch screens, signal generation devices (e.g., speakers), or printers.

By way of example, and not limitation, the processor 860 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 5, multiple processors 860 and/or multiple buses 868 are operable to be used, as appropriate, along with multiple memories 862 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

According to various embodiments, the computer system 800 is operable to operate in a networked environment using logical connections to local and/or remote computing devices 820, 830, 840 through a network 810. A computing device 830 is operable to connect to a network 810 through a network interface unit 896 connected to a bus 868. Computing devices are operable to communicate communication media through wired networks, direct-wired connections or wirelessly, such as acoustic, RF, or infrared, through an antenna 897 in communication with the network antenna 812 and the network interface unit 896, which are operable to include digital signal processing circuitry when necessary. The network interface unit 896 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory 862, the processor 860, and/or the storage media 890 and is operable be a single medium or multiple media (e.g., a centralized or distributed computer system) that store the one or more sets of instructions 900. Non-transitory computer readable media includes all computer readable media, with the sole exception being a transitory, propagating signal per se. The instructions 900 are further operable to be transmitted or received over the network 810 via the network interface unit 896 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

In one embodiment, the computer system 800 is within a cloud-based network. In one embodiment, the server 850 is a designated physical server for distributed computing devices 820, 830, and 840. In one embodiment, the server 850 is a cloud-based server platform. In one embodiment, the cloud-based server platform hosts serverless functions for distributed computing devices 820, 830, and 840.

In another embodiment, the computer system 800 is within an edge computing network. The server 850 is an edge server, and the database 870 is an edge database. The edge server 850 and the edge database 870 are part of an edge computing platform. In one embodiment, the edge server 850 and the edge database 870 are designated to distributed computing devices 820, 830, and 840. In one embodiment, the edge server 850 and the edge database 870 are not designated for distributed computing devices 820, 830, and 840. The distributed computing devices 820, 830, and 840 connect to an edge server in the edge computing network based on proximity, availability, latency, bandwidth, and/or other factors.

It is also contemplated that the computer system 800 is operable to not include all of the components shown in FIG. 5, is operable to include other components that are not explicitly shown in FIG. 5, or is operable to utilize an architecture completely different than that shown in FIG. 5. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

The above-mentioned examples are provided to serve the purpose of clarifying the aspects of the invention, and it will be apparent to one skilled in the art that they do not serve to limit the scope of the invention. By nature, this invention is highly adjustable, customizable and adaptable. The above-mentioned examples are just some of the many configurations that the mentioned components can take on. All modifications and improvements have been deleted herein for the sake of conciseness and readability but are properly within the scope of the present invention. The use of the word “a” or “an” when used in conjunction with the term “comprising” in the claims and/or the specification may mean “one,” but it is also consistent with the meaning of “one or more” or “at least one.” The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements, possesses those one or more steps or elements, but is not limited to possessing only those one or more elements.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, am intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

The invention claimed is:

1. An apparatus for remote infrared ink reading and authenticating comprising: an enclosure;
a visible projection subsystem constructed and arranged to project a visible pattern onto an area having a mark formed with an IR up-converting pigment;
an optical block with a mirror beam splitter and filter providing IR illumination from a laser subsystem, said laser subsystem operates a beam at an excitation wavelength of said IR up-converting pigment;
an imaging subsystem having a camera block with an image sensor for capturing a visible and/or IR signature of the mark when illuminated by said laser subsystem and detected by said image sensor, said laser subsystem converting IR light to visible light wherein said IR up-converting pigment absorbs lower energy photons and emits higher energy photons as fluorescence; and
a processing and control subsystem providing image processing and power management, said processing and control system providing verification of authenticity by detection of said fluorescence.

2. The apparatus for remote infrared ink reading and authenticating according to claim 1 wherein at least two low energy photons are absorbed by said IR up-converting pigment to emit one high energy photon as fluorescence.

3. The apparatus for remote infrared ink reading and authenticating according to claim 2 wherein said IR up-converting pigment is a phosphor.

4. The apparatus for remote infrared ink reading and authenticating according to claim 3 wherein said phosphor having a wavelength peak of 548 nm and 554 nm, and excitation peaks of 950 nm and 980 nm.

5. The apparatus for remote infrared ink reading and authenticating according to claim 2 wherein said IR up-converting pigment includes at least one of doped or undoped metal oxides, doped metal sulfides, metal selenides, metal oxysulfides, rare-earth oxysulfides, and/or mixed oxides.

6. The apparatus for remote infrared ink reading and authenticating according to claim 2 wherein said IR up-converting pigment has a particle size of between about 0.1 microns and 10 microns.

7. The apparatus for remote infrared ink reading and authenticating according to claim 1 wherein said visible project pattern is provided by a red laser pointer with lensing.

8. The apparatus for remote infrared ink reading and authenticating according to claim 1 wherein said IR illumination is an IR Laser pulse radiation projection subsystem that operates at an excitation wavelength between 950 nm and 980 nm.

9. The apparatus for remote infrared ink reading and authenticating according to claim 1 wherein said IR illumination is an IR LED.

10. The apparatus for remote infrared ink reading and authenticating according to claim 1 wherein said optical block includes a lens and beam expander for expanding said beam to a required size to illuminate the mark.

11. The apparatus for remote infrared ink reading and authenticating according to claim 1 wherein said optical block includes a lens and beam shaper for reducing the beam intensity differences over the mark.

12. The apparatus for remote infrared ink reading and authenticating according to claim 1 wherein said filter is selected from a group consisting of: a chromatic filter, a polarization filter, a notch filter and/or a defractive filter.

13. The apparatus for remote infrared ink reading and authenticating according to claim 1 wherein said mark includes at least one visible mark and/or at least one IR mark containing an up-converting pigment.

14. The apparatus for remote infrared ink reading and authenticating according to claim 1 wherein said laser subsystem synchronizes laser pulses with said imaging subsystem.

15. The apparatus for remote infrared ink reading and authenticating according to claim 1 wherein said image sensor is a still image camera.

16. The apparatus for remote infrared ink reading and authenticating according to claim 1 wherein said image sensor is a video camera.

17. The apparatus for remote infrared ink reading and authenticating according to claim 1 wherein said image sensor has a frame rate that is synchronized to a pulse frequency of said laser subsystem.

18. The apparatus for remote infrared ink reading and authenticating according to claim 1 wherein said image sensor is a 1 to 2 MP or higher quality image sensor.

19. The apparatus for remote infrared ink reading and authenticating according to claim 1 wherein said processing and control system provides dual verification of authenticity, wherein a visible mark is decoded by said processor and directed to a database containing location information of an IR mark whereby said IR location is transmitted to said processor and control system using a pulse operable to activate the up-converting pigment, allowing for verification of the mark.

20. The apparatus for remote infrared ink reading and authenticating according to claim 1 wherein said image processing system interfaces with a display and keypad.

21. The apparatus for remote infrared ink reading and authenticating according to claim 1 wherein said power management is further defined as a power management integrated circuit (PMIC).

22. The apparatus for remote infrared ink reading and authenticating according to claim 1 wherein said enclosure is handheld and portable.

23. The apparatus for remote infrared ink reading and authenticating according to claim 1 wherein said enclosure is stationary.

24. The apparatus for remote infrared ink reading and authenticating according to claim 1 wherein said filter is about 550 nm and operable to allow a fluorescing mark to be read by passing it to said imaging subsystem.
